(19) United States
(12) Patent Application Publication
(10) Pub. No.: US 2026/0359379 A1
(43) Pub. Date: Nov. 12, 2026

(54) SEARCH TREES TO SOLVE OPTIMIZATION PROBLEMS

(71) Applicant: NEC Laboratories America, Inc., Princeton, NJ (US)

(72) Inventors: Xujiang Zhao, Hillsborough, NJ (US); Zhengzhang Chen, Princeton Junction, NJ (US); Yanchi Liu, Princeton, NJ (US); Wei Cheng, Princeton Junction, NJ (US); Haifeng Chen, West Windsor, NJ (US)

(21) Appl. No.: 19/672,189

(22) Filed: May 8, 2026

Related U.S. Application Data
(60) Provisional application No. 63/802,787, filed on May 9, 2025.

(51) Int. Cl. G06F 17/11

(52) U.S. Cl. CPC G06F 17/11

(57) ABSTRACT

Systems and methods for building a search tree to solve optimization problems. A computer-implemented method for building a search tree to solve optimization problems, the computer-implemented method including building the search tree with a root node initialized based on a natural language description of an optimization problem by iteratively selecting, by a tree search module, a first node, prompting a first large language model (LLM) to generate at least one child node from the first node, wherein each child node in the search tree represents a partial formulation of a solution to the optimization problem, simulating one of the set of child nodes to obtain an evaluation, backpropagating the evaluation to the tree search, and ending the iterative process when an end condition is met.

### RELATED APPLICATION INFORMATION

This application claims priority to U.S. Provisional Patent Application No. 63/802,787, filed on May 9, 2025, incorporated herein by reference in its entirety.

### BACKGROUND

### Technical Field

The present invention relates to search trees and more particularly to search trees for solving optimization problems.

### Description of the Related Art

Optimization problems are fundamental to numerous disciplines, spanning science, engineering, economics, and operations research, where the goal is to find the best solution from a set of feasible alternatives. Traditional approaches to solving these problems often demand significant domain expertise, rely on specialized algorithms sensitive to problem structure, or incur substantial computational costs. This landscape underscores a persistent need for more versatile and accessible methodologies for tackling a wide array of optimization challenges. Current efforts to employ large language models (LLMs) for optimization can be broadly categorized into prompt-based and learning-based methods. While these methods demonstrate initial promise, they often struggle with generalization across different problem types, necessitating careful and often problem-specific prompt engineering. On the other hand, learning-based methods have shown significant potential. However, such learning-based approaches typically require costly supervised training, demanding extensive labeled datasets and significant computational resources, which can be a barrier to their widespread adoption and adaptability.

### SUMMARY

According to an aspect of the present invention, a computer-implemented method is provided for building a search tree to solve optimization problems. The computer-implemented method including building the search tree with a root node initialized based on a natural language description of an optimization problem by iteratively selecting, by a tree search module, a first node, prompting a first large language model (LLM) to generate at least one child node from the first node, wherein each child node in the search tree represents a partial formulation of a solution to the optimization problem, simulating one of the set of child nodes to obtain an evaluation, backpropagating the evaluation to the tree search, and ending the iterative process when an end condition is met.

According to another aspect of the present invention, a system is provided for building a search tree to solve optimization problems. The system can include a memory device, and one or more processor devices operatively coupled with the memory device to perform operations, the operations including build the search tree with a root node initialized based on a natural language description of an optimization problem by iteratively select, by a tree search module, a first node, prompt a first large language model (LLM) to generate at least one child node from the first node, wherein each child node in the search tree represents a partial formulation of a solution to the optimization problem, simulate one of the set of child nodes to obtain an evaluation, backpropagate the evaluation to the tree search, and end the iterative process when an end condition is met.

According to another aspect of the present invention, a non-transitory computer program product is provided for building a search tree for solving optimization problems. The non-transitory computer program product can include a computer-readable storage medium including a program code, wherein the program code when executed on a computer causes the computer to perform build the search tree with a root node initialized based on a natural language description of an optimization problem by iteratively select, by a tree search module, a first node, prompt a first large language model (LLM) to generate at least one child node from the first node, wherein each child node in the search tree represents a partial formulation of a solution to the optimization problem, simulate one of the set of child nodes to obtain an evaluation, backpropagate the evaluation to the tree search, and end the iterative process when an end condition is met.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for building a search tree to solve optimization problems with large language models (LLMs), in accordance with an embodiment of the present invention;

FIG. 2 is an illustrative example of a practical application for building a search tree to solve optimization problems, in accordance with an embodiment of the present invention;

FIG. 3 is an illustrative example of a practical application for building a search tree to solve optimization problems, in accordance with an embodiment of the present invention;

FIG. 4 is a block/flow diagram illustrating a high-level system/method for building a search tree to solve optimization problems, in accordance with an embodiment of the present invention;

FIG. 5 is a block/flow diagram illustrating an iterative process for building a search tree, in accordance with an embodiment of the present invention;

FIG. 6 depicts a search tree with a path representing a formulation, in accordance with an embodiment of the present invention;

FIG. 7 depicts a search tree adding a child node, in accordance with an embodiment of the present invention;

FIG. 8 depicts a search tree evaluating a node, in accordance with an embodiment of the present invention;

FIG. 9 depicts a search tree integrating the node to the path and backpropagating, in accordance with an embodiment of the present invention;

FIG. 10 is a flow diagram illustrating a system/method for building a search tree to solve optimization problems, in accordance with an embodiment of the present invention; and

FIG. 11 is a block/flow diagram illustrating a system for building a search tree to solve optimization problems, in accordance with an embodiment of the present invention.

### DETAILED DESCRIPTION OF PREFERRED EMBODIMENTS

In accordance with embodiments of the present invention, systems and methods are provided to/for building a search tree to solve optimization problems.

Embodiments of the present invention build a search tree based off an optimization problem to solve the optimization problem. Embodiments of the present invention can first initialize a root node based on the optimization problem. Then the embodiments of the present invention iteratively builds the search tree from the root node. Embodiments of the present invention can generate new nodes by selecting a node and prompting a first large language model (LLM) to generate nodes off the selected node. After the new nodes are generated, a path running through the nodes is evaluated by prompting a second LLM. The evaluation is fed back into the search tree to update the first LLM and the selection process. This iterative process continues until a feasible and optimal solution is achieved.

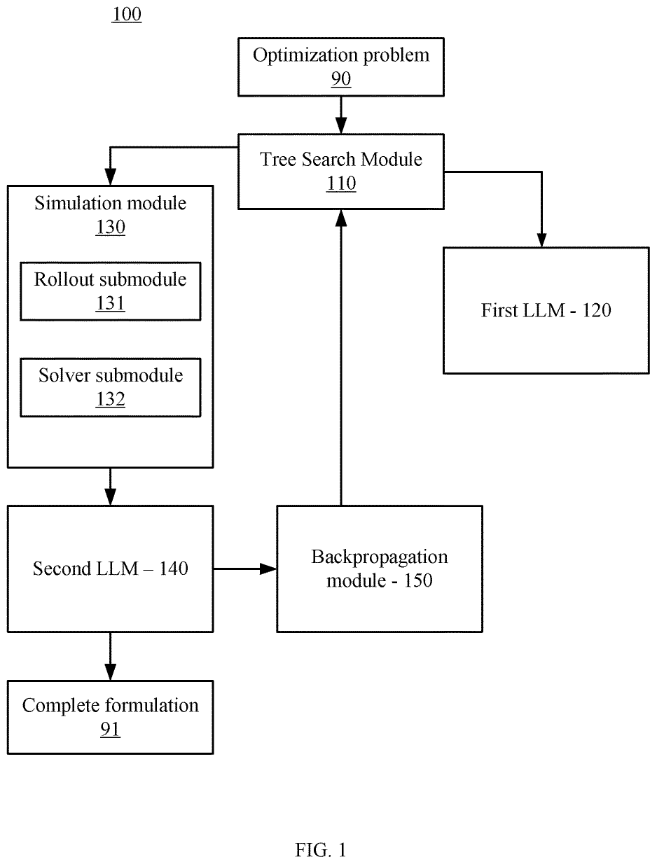

Referring now in detail to the figures in which like numerals represent the same or similar elements and initially to FIG. 1, a high-level system/method 100 for building a search tree to solve optimization problems is illustratively depicted in accordance with one embodiment of the present invention. The system/method 100 can include a tree search module 110, a first large language model (LLM) 120, a simulation module 130, a second LLM 140, and a backpropagation module 150. The tree search module 110 can be a Monte Carlo Tree Search (MCTS) module. The tree search module 110 receives an optimization problem 90 as an input and can initialize a root node representing the optimization problem. The optimization problem 90 can be a natural language input. The tree search module 110 can select a node in a search tree. Each node in the search tree can represent a candidate formulation for solving optimization problems.

The first LLM 120 can be prompted to add at least one child node from the selected node. The tree search module 110 can then select one of the at least one child node to simulate. The tree search module 110 sends the selected child node to the simulation module 130. The simulation module 130 can simulate the partial formulation of a solution represented by the selected child node to obtain a compete formulation of the solution that can later be evaluated. The simulation module 130 can include a rollout submodule 131 and a solver submodule 132. The rollout submodule 131 can simulate a complete solution from the selected child node by iteratively applying actions until a terminal state or fully constructed formulation is reached. Once the rollout submodule 131 obtains a complete formulation, the solver submodule 132 can translate the complete formulation into executable code and running the executable code. The output of the solver submodule 132 is then evaluated by prompting the second LLM 140.

The second LLM 140 can evaluate the quality of the output of the solver submodule 132 and thus the quality of the complete formulation from the rollout submodule 131. The evaluation of the second LLM can later be used for the backpropagation module 150. The second LLM 140 can determine if the output is syntactically valid, solver-compatible, and is a feasible or optimal solution. If the second LLM 140 determines if the output is a feasible or optimal solution, the second LLM 140 outputs the complete formulation 91 of the solution. Feasibility relates to whether the solver submodule 132 ran successfully and found a feasible solution. Optimality relates to whether the solution meets the optimization problem's objective (e.g., minimizes cost). For an example, if the optimization problem is “How many of wraps and platters should be made to minimize the total production time?” then the objective is minimizing total production time.

Once the second LLM 140 evaluates the output, the evaluation is sent to the backpropagation module 150. The backpropagation module 150 can backpropagate a prompt backpropagation and an uncertainty backpropagation to the tree search module 110. Backpropagate can mean sending a signal after an evaluation from the second LLM. The prompt backpropagation can train the tree search module 110 on how to better prompt the first LLM 120 to add child nodes to existing nodes on the search tree. The uncertainty backpropagation can ensure that confident evaluations (low variance) from the second LLM 140 are more propagated than the noisy or uncertain evaluations.

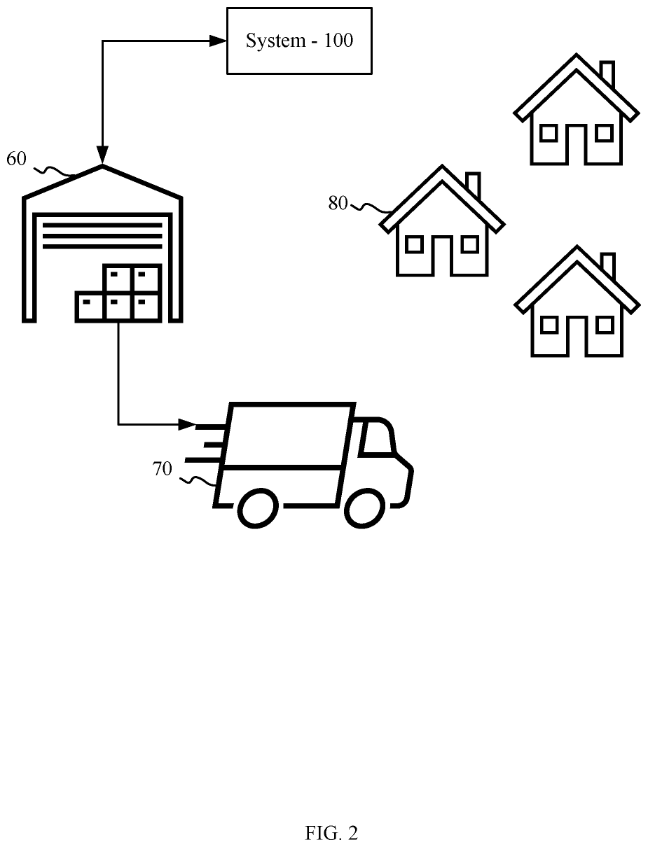

A practical application of embodiments of the invention can include determining the optimal delivery routes for a warehouse manager. Referring to FIG. 2, the warehouse manager 60 uses system 100 to determine the optimal delivery routes for a driver 70. The driver 70 then uses the optimal delivery path to deliver packages to house addresses 80.

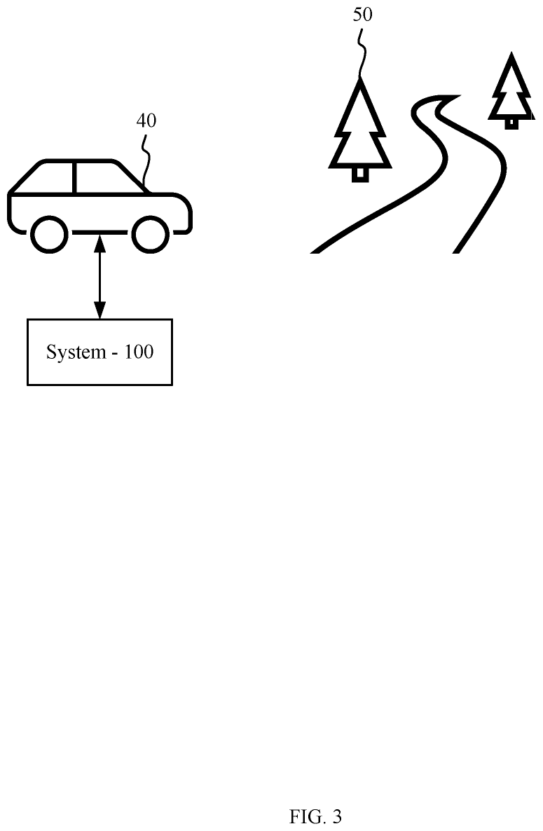

A practical application of embodiments of the invention can include avoiding collisions while driving. Referring to FIG. 3, a vehicle 40 with a processor executing the system/method 100 detects objects on the road 50. The vehicle 40 determines that avoiding objects is an optimization problem and has system/method 100 solve the optimization problem. After obtaining the solution to the optimization problem, the vehicle 40 corrects its path based on the solution.

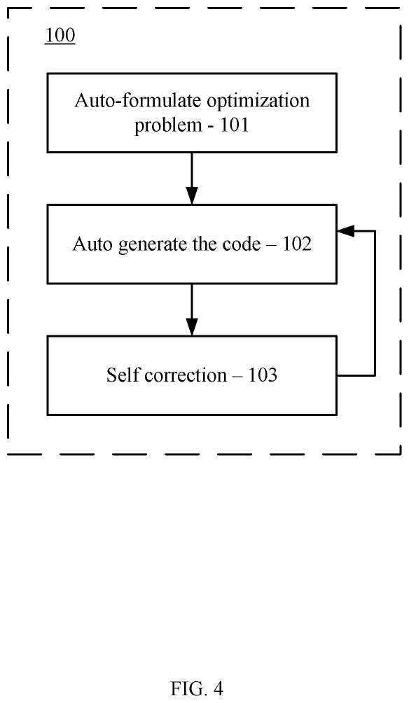

Referring to FIG. 4, a high level flow chart of system/method 100 for building a search tree to solve optimization problems is illustratively depicted in accordance with one embodiment of the present invention. The system/method 100 can auto-formulate an optimization problem at block 101. In block 101, the optimization problem is decomposed into a search tree. Optimization modeling is inherently complex, involving multiple interconnected components. A Structured Decomposition approach can allow the system/method 100 to sequentially explore each model component rather than searching for entire formulations at once, potentially leading to more efficient search.

Specifically, the system/method 100 structurally decomposes the auto formulation process into five distinct stages: m=⊕_i\hat{ }5m_m_1: Sets; m_2: Parameters; m_3: Variables; m_4: Objective; m_5: Constraints Given a problem description d, the joint distribution p_(φ, ψ)(m, c|d) is decomposed hierarchically:

$${p}_{ϕ , ψ} ( m , c \vert d ) = {p}_{ψ} ( c \vert m ) {\prod }_{i = 1} {p}_{ϕ} ( {m}_{i} \vert {m}_{< i} , d )$$

For example, the problem description can be “A new fast food place makes wraps and platters. How many of wraps and platters should be made to minimize the total production time?” The stages would be parameters and objective. The parameter stage would be the wraps and platters. The objective stage would be to minimize total production.

Then the system/method 101 considers to build a search tree to search the best formulation. The tree search module 110 constructs a search tree of depth 5 to explore possible formulations, where each of the five levels corresponds to a component in the structured decomposition (m_1 to m_5). Nodes in this tree contain component formulations, and a complete formulation is represented by a path from the root to a terminal node, with each path yielding a unique formulation.

In an embodiment of the present invention, there can be a six element schema. The six elements are type, sets, parameters, variables, objective, and constraints. These elements can guide LLM-driven expansion and enable structured and interpretable search.

An enhancement in the present system/method is the introduction of the Type element, which identifies the high level category of the optimization problem, such as linear programming, or integer programming. This early-stage classification provides a form of global guidance G_{g} before the first LLM 120 begins constructing detailed formulations.

The Type element helps the model establish a coherent mental model of the task at hand. This early guidance helps the first LLM 120 form a coherent task model, reducing ambiguity and ensuring consistency in later decisions, especially for complex or unfamiliar problems. The first LLM 120 can be prompted to construct formulations incrementally across these six elements. Each node encodes a partial formulation, while the entire path of nodes defines the complete model. This modular design enables semantic consistency, local reasoning, and flexible correction, making it ideal for test-time inference.

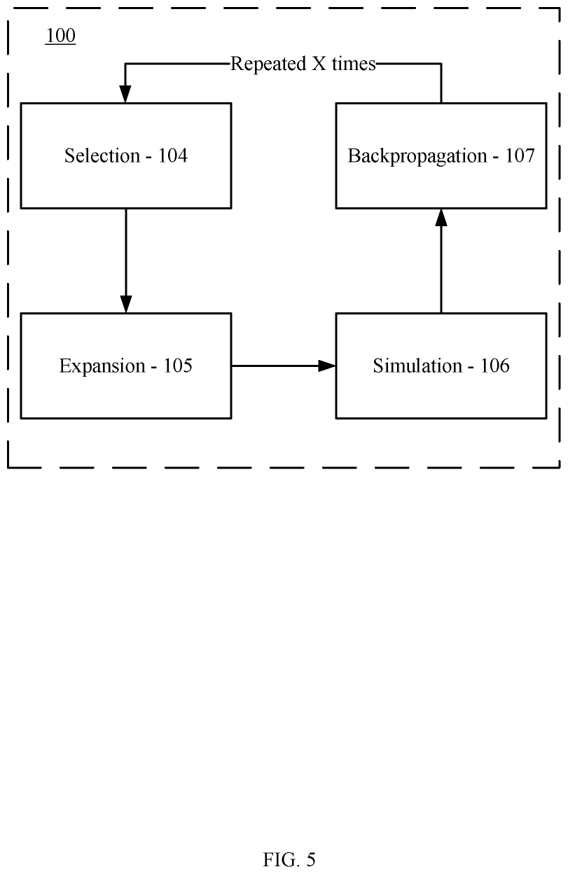

Now referring to FIG. 5, the system/method 100 can build a search tree from the optimization problem through an iterative process. The system/method 100 can begin with selection at block 104. Given a current tree state, the tree search module 110 can choose a promising node s to expand by traversing the tree from the root using the Upper Confidence Bound (UCB) rule. During the entire search process, each node s continuously maintains two statistics based on solver feedback collected from past rollouts: a total visit count Nₛ and an average reward Qₛ. Given a parent node s, the next child s_{child} ∈Child(s) is selected according to:

$${s}_{child} = arg {max}_{{s}^{′} ∈ Child ( s )} [ {Q}_{{s}^{′}} + c \cdot \sqrt{\frac{2 log {N}_{s}}{{N}_{{s}^{′}}}} ]$$

where c is an exploration constant controlling the degree of exploration.

After selecting a node for exploration, the system/method 100 dynamically expands the selected node at block 105. Unlike traditional MCTS, where the action space is predefined and finite, the space of valid optimization formulations is vast and unstructured. Rather than relying on a static set of predefined actions, the system/method 100 prompts the first LLM 120 to produce new child nodes tailored to the current partial formulation of the solution to the optimization problem, which increases the breadth of the search and facilitates solving more complex optimization problems.

In the expansion phase, instead of using a fixed action set, the system/method 100 prompts the first LLM 120 to propose new child nodes to the search tree by extending the current formulation fₛ. Since each generated node represents a partial formulation of a solution, the first LLM 120 is in effect prompted to generate what the first LLM 120 determines is a partial solution to the optimization problem. This dynamic expansion enables the system/method 100 to incrementally build increasingly complete and accurate formulations of the solution to the optimization problem. Specifically, given a partial formulation fₛ, the system/method 100 queries the LLM with:
Prompt (fₛ)→{fₛ_{₁}, fₛ₂ . . . , fₛ_{ₖ}}
   where each fₛ_{₁} represents a new child node corresponding to a modified or extended version of the formulation.

This dynamic expansion enables a flexible and expressive search over a large and diverse formulation space, supporting insertion of variables, transformation of objectives, and refinement of constraints.

In one embodiment of the present invention, the expansion in block 105 can be performed on non-leaf nodes of the search tree. This flexibility accounts for the non-linear structure of optimization problem formulation: elements such as variables and constraints may depend on or revise earlier components. The system/method 100 can revisit and refine earlier decisions based on updated feedback, enabling deeper and more accurate formulations over time.

In one embodiment of the present inventions, each element layer l is assigned a local expert-guided knowledge base [symbol] ₗ that guides the expansion of any node (whether it's leaf or non-leaf nodes of the search tree) within that layer. This knowledge base is constructed from accumulated reasoning signals derived from the evaluation of past generated formulations.

After a new child node has been generated at block 105, the system/method 100 simulates a new child node at block 106 using the simulation module 130. If there are multiple new child nodes generated, a random child node is selected for simulation. The simulation module 130 comprises two key operations performed on the expanded node s: rollout and evaluation.

Rollout refers to the process of simulating a complete solution from a specific node by iteratively applying actions until a terminal state or fully constructed formulation is reached. This can be accomplished by the rollout submodule 131. Once the complete formulation is obtained, the system/method can begin evaluating the complete formulation's quality by translating the formulation into executable code and running the formulation through a solver submodule 132. The simulation step determines whether the formulation is syntactically valid, solver-compatible, and capable of producing a feasible or optimal solution. The purpose of the evaluation is to obtain the uncertainty and reasoning signals, which serve to guide the subsequent search process.

Each formulation fₛ at node s is translated into code and solved by a numerical solver, yielding an output x*. Subsequently, a reward R (fₛ,x*) is assigned to the output x*, which captures several factors: feasibility, optimality, and error penalty. Feasibility relates to whether the solver ran successfully and found a feasible solution. Optimality relates to whether the solution meets the problem's objective (e.g., minimizes cost). Error penalty relates to whether the code execution failed or returned invalid outputs. The reward is computed as a weighted sum:

R(fₛ,x*)=α· [symbol] _{feasible}+β·objective_score(fₛ,x*)−γ· [symbol] ₑᵣᵣₒᵣ

where α, β, and γ are hyperparameters, and [symbol] _{feasible}, [symbol] ₑᵣᵣₒᵣ are binary indicators. [symbol] _{feasible} relates to feasibility, [symbol] ₑᵣᵣₒᵣ relates to the error penalty, and the term objective_score relates to optimality. The term objective_score (fₛ, x*) represents a subjective judgment of the solution quality, based on both the original formulation and the computed result. The term objective_score is obtained from the second LLM 140. Specifically, the system/method 100 prompts the second LLM 140 to act as a lightweight evaluator (or “judger”) that assesses how well the solution aligns with the intent and structure of the formulation fₛ. This allows the system/method 100 to estimate relative solution quality even in the absence of exact ground-truth labels or reference objectives, and is particularly useful in cases involving heuristic or approximate solvers.

Beyond rewards, the system/method 100 employs the second LLM 140 to evaluate each element in the generated formulation, producing corresponding reasoning signals for each layer. Specifically, for each layer l and its associated node sₗ in the formulation, the system/method 100 defines the reasoning signals as a triplet [symbol] ₗ=(tₛ_{ₗ}, Eₛ_{ₗ}, Gₗ), where tₛ denotes a one-time trigger indicating node activation status of node sₗ, Eₛ_{ₗ} represents the reason explaining whether node sₗ is appropriate, and Gₗ provides layer-level prompt guidance for revision when the node sₗ is deemed inappropriate. These signals are propagated backward, serving as critical information that influences the subsequent search process of the tree search module 110.

After evaluating a candidate formulation and obtaining its reward and reasoning signals, the backpropagation module 150 performs backpropagation to update the tree search module 110 and inform future decisions. In one embodiment of the present invention, for standard MCTS, this step updates visit counts and value function along the path from the current node back to the root. The system/method 100 extends this process with two innovations tailored for language-model-guided reasoning: prompt backpropagation and uncertainty propagation.

For prompt backpropagation, traditional MCTS propagates only scalar rewards, thereby overlooking rich contextual feedback, especially when the formulation itself is imperfect. In system/method 100, the reasoning signals [symbol] ₗ for each layer l obtained from the second LLM 140 are treated as feedback. Specifically, for each node s at each level l along the path used to generate the formulation, the backpropagation module 150 propagate the corresponding reasoning signals [symbol] ₗ backward, updating the node's state until reaching the root. If a trigger tₛ_{ₗ} is present in [symbol] ₗ, the corresponding node s is regarded as activated, meaning it becomes eligible for further expansion. In addition, the system/method 100 constructs a knowledge base [symbol] ₗ for each layer l to continuously accumulate prompt guidance Gₗ from [symbol] ₗ. This guidance is then incorporated into future prompt construction during dynamic expansion, enabling reasoning aware search and formulation refinement. However, given the uncertainty associated with LLM outputs, the backpropagation module 150 additionally computes local uncertainty

$${U}_{{s}_{l}}^{local}$$

based on Eₛ_{ₗ}, using predictive entropy:

$${U}_{{s}_{l}}^{local} = {𝔼}_{{E}_{{s}_{l}}} [ \frac{1}{\vert {E}_{{s}_{l}} \vert} {\sum }_{{a}_{i}}^{{E}_{{s}_{l}}} - log ℙ ( {a}_{i} \vert {a}_{0} , … {a}_{i - 1} ) ] ,$$

where aᵢ is the i-th token of Eₛ_{ₗ}. Only when

$${U}_{{s}_{l}}^{local}$$

exceeds a threshold η and a trigger tₛ_{ₗ} is present will the backpropagation module 150 activate the corresponding node s and perform prompt backpropagation.

The uncertainty backpropagation modifies the reward signal, leveraging the second LLM 140 as a semantic scorer enables task-agnostic reward estimation, but introduces high variance due to the subjectivity and variability of LLM outputs. This makes reward propagation unstable, especially for complex or ambiguous formulations. To mitigate this, the backpropagation module 150 incorporates reward uncertainty as global uncertainty during backpropagation. Specifically, the backpropagation module 150 estimates the semantic uncertainty at each evaluated node s by repeatedly sampling objective_score (fₛ, x*), yielding an uncertainty measure

$${U}_{s}^{global} .$$

The backpropagation module 150 then down-weights the impact of uncertain evaluations during backpropagation. For each node s′ of the search tree on the path from s to the root, the tree search module 110 update its value using an uncertainty-weighted average:

$${Q}_{{s}^{′}} ← {Q}_{{s}^{′}} + {ρ}_{s} \cdot \frac{\overline{R} ( {f}_{s} , x \text{*)} - {Q}_{{s}^{′}}}{{N}_{{s}^{′}}}$$

where the trade-off factor is defined as a decreasing function of uncertainty:

$${ρ}_{s} = exp ( - {U}_{s}^{global} ) ,$$

and R̅(fₛ, x*) is the average reward based on multiple samplings. This formulation ensures that confident evaluations (low variance) are strongly propagated, while noisy or uncertain judgments have limited influence on tree statistics. Finally, for every node s′ on the path, the system/method 100 also increments the visit count for the selection phase: N_{s′}→N_{s′}+1. These updates to Q_{s′} and N_{s′} are used in the next selection step to determine which parts of the tree should be further explored.

To quantify the semantic uncertainty associated with each candidate formulation node, the backpropagation module 150 adopts an entropy-based measure grounded in recent work on meaning-equivalence in language model outputs. Rather than assessing variability over surface-level generations, the backpropagation module 150 considers the distribution over underlying semantic classes-clusters of sequences that encode the same meaning. This approach captures uncertainty at the level of intended formulation semantics, aligning closely with the structural fidelity required in optimization tasks.

Formally, given a formulation fₛ and input context x, the backpropagation module 150 samples a set of sequences {s} from the language model and group them into equivalence classes {M}, where each class Mᵢ corresponds to a distinct semantic meaning. The backpropagation module 150 then computes the semantic entropy SE(x), which serves as the measure of uncertainty, using the following definition:

SE(x)=−Σₘp(m|x)log p(m|x)=−Σₘ(Σ_{s∈m}p(s|x))log(Σ_{s∈m}p(s|x))

where m is the same as M. This quantity reflects the dispersion of probability mass over meaning-equivalent outputs, with higher entropy indicating greater ambiguity or instability in the model's semantic preference.

Since the full distribution over all possible meaning classes is intractable, the backpropagation module 150 approximates SE(x) using Monte Carlo sampling over equivalence classes identified from sampled generations. Specifically, the backpropagation module 150 estimates the expectation via:

$$SE ( x ) \approx - {\vert M \vert}^{- 1} {\sum }_{i = 1}^{\vert M \vert} log p ( {M}_{i} \vert x ) ,$$

where Mᵢ denotes the i-th sampled equivalence class and p(Mᵢ|x) is its aggregated likelihood.

This entropy-based uncertainty measure serves as a principled signal during reward backpropagation in MCTS. Nodes associated with high semantic entropy are treated as less reliable and receive attenuated influence during search. Compared to naive variance-based metrics, semantic entropy offers a deeper view of model uncertainty grounded in meaning-level diversity, leading to improved robustness in structurally complex tasks.

The process of selection 104, expansion 105, simulation 106, and backpropagation 107 can be repeated iteratively to build the search tree. The iterative process can stop when an end condition is met. In one embodiment of the present invention, the end condition is a selection repetition threshold where the same node is selected repeatedly. In one embodiment of the present invention, the end condition is a search tree level threshold which is determined by the number of parameters used to solve the optimization problem.

In an embodiment of the present invention, the first LLM and the second LLM each operate in a zero-shot setting without task-specific fine-tuning. In other words, the first LLM and the second LLM can each operate without prior training.

Referring back to FIG. 3, after the optimization problem has been broken down into a search tree in block 101, code is auto-generated by the system/method 100 in block 102. Once a complete mathematical formulation fₛ is selected via the tree search module 110, at block 102, the system/method 101 proceeds to convert the mathematical formulation into executable code for a solver. A complete mathematical formulation can be represented by a path in the search tree. This step is handled by an LLM that translates mathematical descriptions into solver-specific code, such as Python scripts utilizing CVXPY, Pyomo, or Gurobi interfaces.

The process relied on the system/method 101 to generate executable code can involve analyzing the mathematical formulation to identify the appropriate optimization solver type (linear, nonlinear, integer, etc.). The process can further include translating mathematical constraints into programmatic constraints with proper syntax. The process can further include setting up the objective function with correct variable references and mathematical operations. The process can further include configuring solver-specific parameters such as tolerance levels, iteration limits, and solution methods. The process can further include implementing proper data structures to represent the problem variables and constraints. The process can further include generating appropriate input/output handling code to process problem data and return optimized solutions. The process can further include validation checks to ensure problem feasibility and solution quality. The process can further include optimizing code efficiency to handle larger-scale problems when needed.

For code generation, given a formulation fₛ, the system/method 100 constructs a structured natural language prompt that requests the LLM to generate solver-ready code. The prompt includes explicit instructions, such as variable definitions, objective specification, and constraint declarations. Formally, the code generation function is:

CodeGen(fₛ)=LLM(Prompt_{code}(fₛ))

The generated code is then executed to retrieve the solution x*, or produce an error log in case of failure.

The solver execution output provides critical feedback about the quality and correctness of the formulation. Based on the outcome, the system/method 100 can identify three possible scenarios. One scenario can be a success scenario. In the success scenario, the solver returns a feasible and optimal solution. Feasible can mean operable or functional solution. Optimal can mean when the solution meets the problem's objective (e.g., minimize cost). The search then terminates. Another scenario can be a soft failure scenario. In the soft failure scenario, the code executes but returns an infeasible or suboptimal solution. This suggests issues in formulation quality. Another scenario can be a hard failure scenario. In the hard failure scenario, the code fails to run due to syntax errors or unsupported constructs.

In failure cases, the system/method self-corrects at block 103. The system/method 100 can invoke a self-correction routine that either revises the generated code or rolls back to a prior formulation node for further expansion. Specifically, for soft failures, the feedback is encoded into a correction prompt to the LLM, refining either the formulation or the code (e.g., modifying constraints or variable bounds). For hard failures, the system/method 100 identifies problematic code segments (e.g., invalid function calls) and prompts the LLM to regenerate the code with additional constraints (e.g., use only CVXPY-supported syntax). This feedback loop ensures that system/method 100 does not rely on a single-shot solution, but instead iteratively refines.

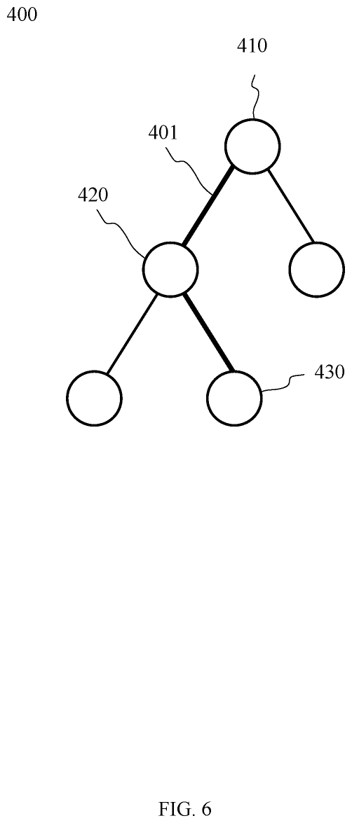

Referring to FIG. 6, a search tree 400 is depicted having nodes 410, 420, and 430 and a path 401. The nodes 410, 420, and 430 can represent partial formulations of the optimization problem and the path 401 can represent the complete formulation.

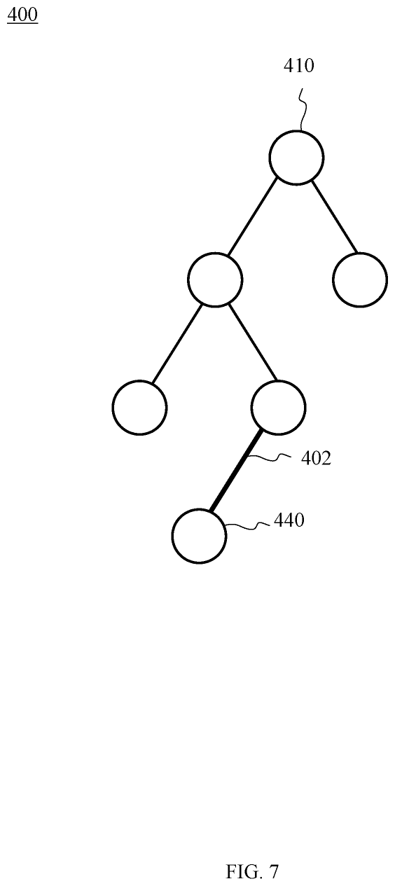

Referring to FIG. 7, a child node 440 is added 402 to the search tree 400. The child node can be added by an LLM.

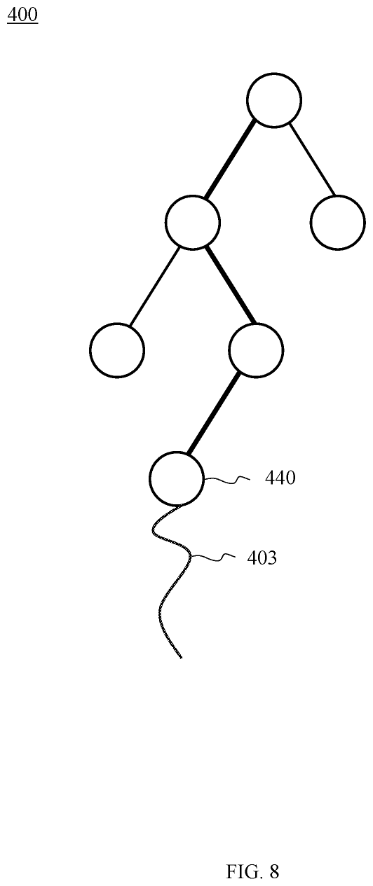

Referring to FIG. 8, the child node 440 is then evaluated 403 by an LLM for correctness.

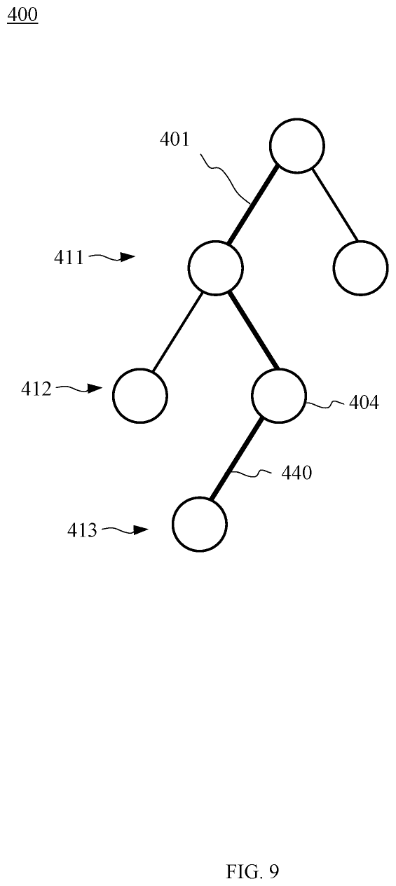

Referring to FIG. 9, once the child node 440 is evaluated, the child node 440 becomes part of the search tree 400 and the evaluation of the child node is backpropagated 404 through the search tree. Each level 411, 412, 413 refers to a parameter used to solve the optimization problem. If the evaluation shows that the child node 440 is optimal or feasible, then the child node 440 becomes part of path 401. Otherwise, the process shown through FIGS. 5-8 repeats itself.

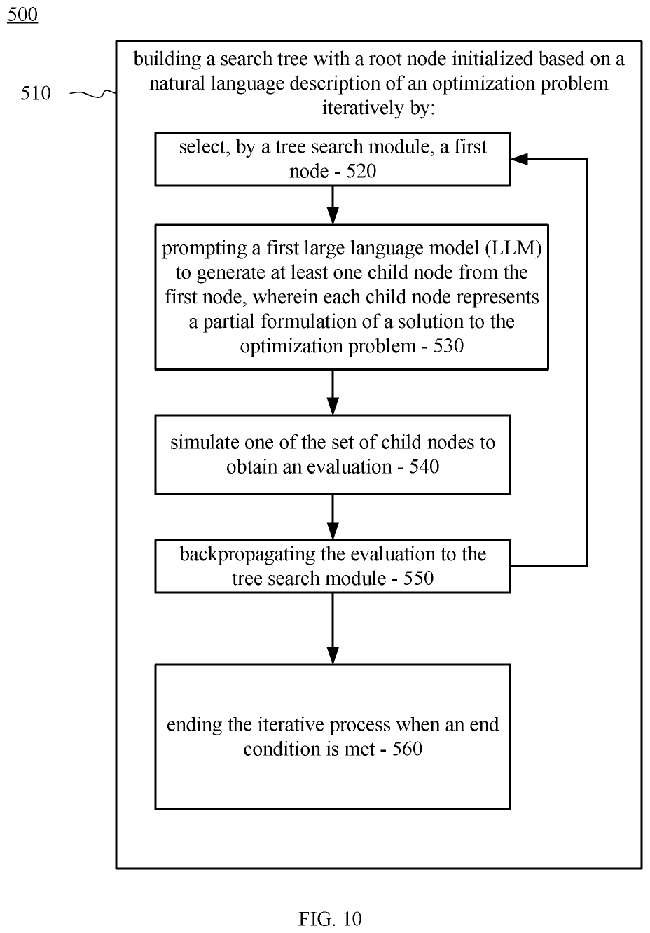

Referring now to FIG. 10, a block/flow diagram 500 of a high-level overview of building a search tree to solve optimization problems, in accordance with an embodiment of the present invention.

At block 510, a search tree is being built iteratively with a root node initialized based on a natural language description of an optimization problem. The optimization problem can be structurally decomposed into five distinct stages: sets, parameters, variables, objective, and constraints. The search tree can have a depth of five where each of the five levels corresponds to one of the distinct stages. Nodes in this tree contain partial formulations, and a complete formulation is represented by a path from the root to a terminal node, with each path yielding a unique formulation.

At block 520, a first node is selected by a tree search module. The selection identifies the node with the most potential for subsequent node expansions. In an embodiment of the present invention, the selection can be accomplished by iteratively selecting the child with the largest (Upper Confidence Bound for Trees) value until the tree search module 110 reaches the leaf node. In an embodiment of the present invention, the selection process can be terminated early when an active non-leaf node is determined by a trigger tₛ.

At block 530, at least one child node is generated from the first by prompting a first large language model (LLM), wherein each child node represents a partial formulation. The first LLM can accomplish this by sampling.

At block 540, one of the set of child nodes is simulated to obtain an evaluation. The simulation can start by rolling out the child nodes to obtain a complete formulation. The complete formulation is then fed to a solver module to generate a solver output. The solver output is then evaluated by a second LLM to obtain an evaluation.

At block 550, the evaluation can be backpropagated to the tree search module. The backpropagation can include prompt backpropagation and uncertainty backpropagation. A reward signal and an uncertainty signal can be generated based on the evaluation from the second LLM. The reward signal can inform prompt backpropagation and the uncertainty signal informs uncertainty propagation. The backpropagation helps the search tree balance exploitation of reliable formulations and exploration of uncertain but potentially promising candidates.

At block 560, the iterative process ends when an end condition is met. In one embodiment of the present invention, the end condition is a selection repetition threshold where the same node is selected repeatedly. In one embodiment of the present invention, the end condition is a search tree level threshold which is determined by the number of parameters used to solve the optimization problem. For example, the search tree level threshold can be six to reflect the six parameters used to solve the optimization problem.

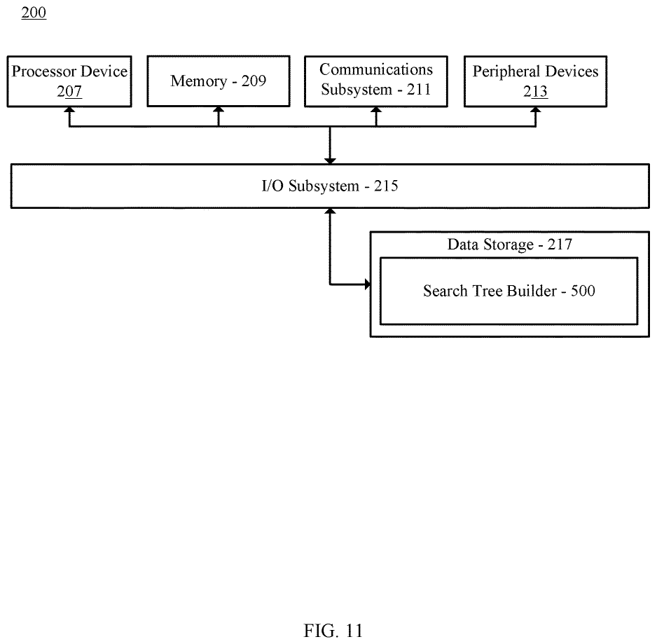

Referring now to FIG. 11, a block diagram of a computer system for video analysis, in accordance with an embodiment of the present invention.

The computing device 200 illustratively includes the processor device 207, the input/output (I/O) subsystem 215, the memory 209, the data storage device 217, and the communications subsystem 211, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 209, or portions thereof, may be incorporated in the processor device 207 in some embodiments.

The processor device 207 may be embodied as any type of processor capable of performing the functions described herein. The processor device 207 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 209 may be embodied as any type of volatile or non-volatile memory or data storage capable of performing the functions described herein. In operation, the memory 209 may store various data and software employed during operation of the computing device 200, such as operating systems, applications, programs, libraries, and drivers. The memory 209 is communicatively coupled to the processor device 207 via the I/O subsystem 215, which may be embodied as circuitry and/or components to facilitate input/output operations with the processor device 207, the memory 209, and other components of the computing device 200. For example, the I/O subsystem 215 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 215 may form a portion of a system-on-a-chip (SOC) and be incorporated, along with the processor device 207, the memory 209, and other components of the computing device 200, on a single integrated circuit chip.

The data storage device 217 may be embodied as any type of device or devices configured for short-term or long-term storage of data such as, for example, memory devices and circuits, memory cards, hard disk drives, solid state drives, or other data storage devices. The data storage device 217 can store program code for a search tree builder 500. Any or all of these program code blocks may be included in a given computing system.

The communications subsystem 211 of the computing device 200 may be embodied as any network interface controller or other communication circuit, device, or collection thereof, capable of enabling communications between the computing device 200 and other remote devices over a network. The communications subsystem 211 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 200 may also include one or more peripheral devices 213. The peripheral devices 213 may include any number of additional input/output devices, interface devices, and/or other peripheral devices. For example, in some embodiments, the peripheral devices 213 may include a display, touch screen, graphics circuitry, keyboard, mouse, speaker system, microphone, network interface, and/or other input/output devices, interface devices, global positioning system (GPS), camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for building a search tree to solve optimization problems, the computer-implemented method comprising:
building the search tree with a root node initialized based on a natural language description of an optimization problem by iteratively:
selecting, by a tree search module, a first node;
prompting a first large language model (LLM) to generate at least one child node from the first node, wherein each child node in the search tree represents a partial formulation of a solution to the optimization problem;
simulating one of the set of child nodes to obtain an evaluation;
backpropagating the evaluation to the tree search; and
ending the iterative process when an end condition is met.

2. The method of claim 1, wherein simulating at least one child node further includes:
rolling out the child node to obtain a complete formulation of the solution to the optimization problem;
generating a solver output for the complete formulation; and
prompting a second LLM to evaluate the solver output and obtain an evaluation.

3. The method of claim 2, wherein the first LLM and the second LLM each operate in a zero-shot setting without task-specific fine-tuning.

4. The method of claim 1, wherein the evaluation is backpropagated using uncertainty backpropagation and prompt backpropagation.

5. The method of claim 1, wherein the tree search module is a Monte Carlo Tree Search (MCTS) module.

6. The method of claim 1, wherein the end condition is a search tree level threshold based on a number of parameters used to solve the optimization problem.

7. The method of claim 1, wherein the end condition is a selection repetition threshold.

8. The method of claim 1, wherein each layer of the search tree corresponds to a knowledge base.

9. A system, comprising:
a memory device; and
one or more processor devices operatively coupled with the memory device to perform operations, the operations including:
build a search tree with a root node initialized based on a natural language description of an optimization problem by iteratively:
select, by a tree search module, a first node;
prompt a first large language model (LLM) to generate at least one child node from the first node, wherein each child node in the search tree represents a partial formulation of a solution to the optimization problem;
simulate one of the set of child nodes to obtain an evaluation;
backpropagate the evaluation to the tree search; and
end the iterative process when an end condition is met.

10. The system of claim 9, wherein the operation to simulate at least one child node further includes:
roll out the child node to obtain a complete formulation of the solution to the optimization problem;
generate a solver output for the complete formulation; and
prompt second LLM to evaluate the solver output and obtain an evaluation.

11. The system of claim 10, wherein the first LLM and the second LLM each operate in a zero-shot setting without task-specific fine-tuning.

12. The system of claim 9, wherein the evaluation is backpropagated using uncertainty backpropagation and prompt backpropagation.

13. The system of claim 9, wherein the tree search module is a Monte Carlo Tree Search (MCTS) module.

14. The system of claim 9, wherein the end condition is a search tree level threshold based on a number of parameters used to solve the optimization problem.

15. A non-transitory computer program product comprising a computer-readable storage medium including a program code, wherein the program code when executed on a computer causes the computer to perform:
build a search tree with a root node initialized based on a natural language description of an optimization problem by iteratively:
select, by a tree search module, a first node;
prompt a first large language model (LLM) to generate at least one child node from the first node, wherein each child node in the search tree represents a partial formulation of a solution to the optimization problem;
simulate one of the set of child nodes to obtain an evaluation;
backpropagate the evaluation to the tree search; and
end the iterative process when an end condition is met.

16. The computer program product of claim 15, wherein the program code to simulate at least one child node further includes:
roll out the child node to obtain a complete formulation of the solution to the optimization problem;
generate a solver output for the complete formulation; and
prompt second LLM to evaluate the solver output and obtain an evaluation.

17. The computer program product of claim 16, wherein the first LLM and the second LLM each operate in a zero-shot setting without task-specific fine-tuning.

18. The computer program product of claim 15, wherein the evaluation is backpropagated using uncertainty backpropagation and prompt backpropagation.

19. The computer program product of claim 15, wherein the tree search module is a Monte Carlo Tree Search (MCTS) module.

20. The computer program product of claim 15, wherein the end condition is a search tree level threshold based on a number of parameters used to solve the optimization problem.
